(19) United States
(12) Patent Application Publication
(10) Pub. No.: US 2007/0126193 A1
(43) Pub. Date: Jun. 7, 2007

(54) Sanitation handle for carts

(76) Inventor: Howard Hess, Nipomo, CA (US)

Correspondence Address: ANDREW SCHROEDER, 500 S. BROADWAY, SUITE 222, SANTA MARIA, CA, 93454, US

(21) Appl. No.: 11/293,742

(22) Filed: Dec. 1, 2005

(51) Int. Cl. B62D 39/00

(52) U.S. Cl. 280/33.992

(57) ABSTRACT

A sanitation handle for carts and railings comprising an open tubular flexible sleeve member which is expandable for receiving at least a portion of the main handle member of a cart, said flexible sleeve member having a first open end and a second open end and a slit formed longitudinally along length of flexible sleeve member.

### FIELD OF THE INVENTION

The present invention is in the area of sanitation products and pertains more particularly to sanitation handles for carts.

### BACKGROUND OF THE INVENTION

To date there are not many suitable products in the marketplace which protect people from germs on various carts they come into contact on a daily basis. A typical shopping cart in a grocery store may come into contact with more than ten different people per day who bring with them a panoply of different viruses and bacteria on their hands. These viruses and bacteria may bring about severe sickness and disease, some of which may become fatal.

For example, in every grocery store there is a meat and poultry aisle. Oftentimes, the meat which are wrapped in these aisles are poorly wrapped and are not properly refrigerated. When a customer picks up a package of poultry which is leaking, Salmonella bacteria may cover their hands. Subsequently, when the customer resumes shopping the customer will place their hand back onto the handle of the shopping cart thereby depositing millions of these bacteria upon the handle. Salmonella bacteria are known to cause food poisoning as well as typhoid. The same problem also inheres with the handling of ground beef which is often infested with Escherichia coli which may also lead to food poisoning as well as the fatal Hemolytic Uremic Syndrome.

Another common problem associated with shopping carts is the fact that many shoppers carry germs which may infect other shoppers with the cold, influenza (flu), and other viral germs. As a shopper touches the handle of a shopping cart the deposited germs are picked up by the next shopper who subsequently uses the shopping cart. Unfortunately, one shopping cart can possibly infect scores of other shoppers and consequently make them sick.

Another problem associated with shopping carts are babies who ride in the front seat. This problem is actually twofold: the baby deposits a substantial amount of germs onto the shopping cart and the baby may become infected with the pre-existing germs on the shopping cart. And since a baby's immune system is not fully developed the danger is multiplied.

There is prior art used in the marketplace which comprises a seat for a baby along with a handle adaptable for use with a shopping cart. The problem with this device is the fact that it is large and cumbersome. And given the price points for this product, economic feasibility is another concern. Moreover, this apparatus is largely useless to those who use shopping carts without small children to place into a shopping cart.

Therefore, what is clearly needed is a recyclable article of manufacture for protecting people from germs associated with various carts.

### SUMMARY OF THE INVENTION

The present invention in some preferred embodiments consists of a sanitation handle for carts and railings comprising: an open tubular flexible sleeve member which is expandable for receiving at least a portion of the main handle member of a cart, said flexible sleeve member having a first open end and a second open end and a slit formed longitudinally along length of flexible sleeve member.

Preferred embodiments may vary with the present invention. Although the aforementioned preferred embodiment was described with several components, the summary of the invention should not be construed to be limiting the scope of the present invention. Several of these components may be optional depending upon the circumstances.

### BRIEF DESCRIPTION OF THE DRAWING FIGURES

FIG. 1 is a perspective view of a preferred embodiment of the present invention.

FIG. 2 is a cross-sectional view of a preferred embodiment of the present invention.

FIG. 3 is a perspective view of a preferred embodiment of the present invention.

FIG. 4 is a perspective view of a preferred embodiment of the present invention.

FIG. 5 is a perspective view of a preferred embodiment of the present invention.

FIG. 6 is a perspective view of a preferred embodiment of the present invention.

FIG. 7 is a perspective view of a preferred embodiment of the present invention.

### DESCRIPTION OF PREFERRED EMBODIMENTS

According to a preferred embodiment of the present invention, a unique article of manufacture is used to protect people from harmful pathogens found on various carts. The present invention is described in enabling detail below.

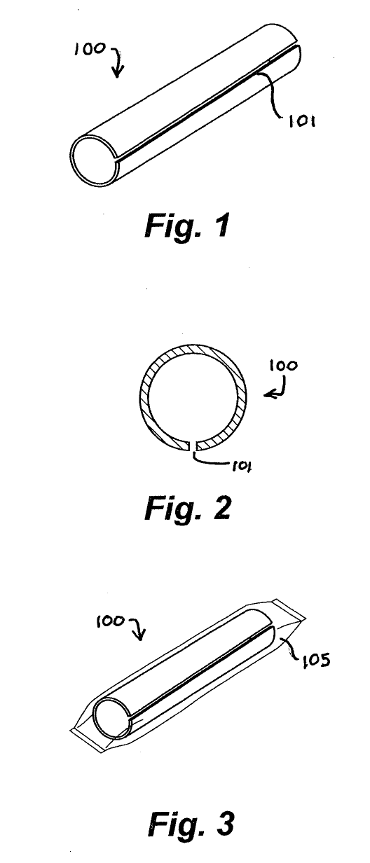

FIG. 1 is a perspective view of a preferred embodiment of the present invention. Cart handle 100 is cylindrical in shape and is sized to fit a handle of a cart. On one side of cart handle 100 is a slit 101. Slit 101 is made along the length of cart handle 100. Slit 101 enables cart handle 100 to be wrapped around the handle of a cart. FIG. 2 is a cross-sectional view of the cart handle 100.

In some preferred embodiments cart handle 100 is made of recycled paper. In other preferred embodiments cart handle 100 may be made from cardboard, recycled cardboard, plastic, or vinyl. However, it is not specifically required that said materials compose cart handle 100. There abound a panoply of other suitable materials which may be equally useful for the task. In addition, it should be pointed out here that some preferred embodiments of the present invention may be recyclable.

FIG. 3 is a perspective view of another preferred embodiment of the present invention. Cart handle 100 is affixed with a label 300 used for printing indicia 301. Indicia 301 may embody many different forms including advertising, trademarks, instructions, etc. Label 300 may be any garden variety adhesive label with a sticky side on one side and a side for writing or printing indicia 301 on the other side. Or, in other preferred embodiments, label 300 may be affixed to the cart handle 100 through use of other well-known alternatives and means. In other preferred embodiments indicia 301 may be printed directly upon cart handle 100. Moreover, in some preferred embodiments, label 300 is also sanitized with disinfectant means.

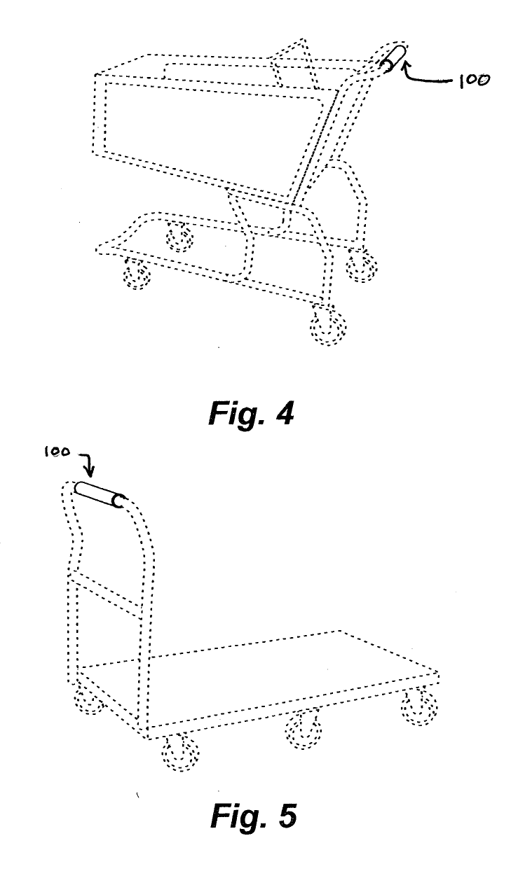

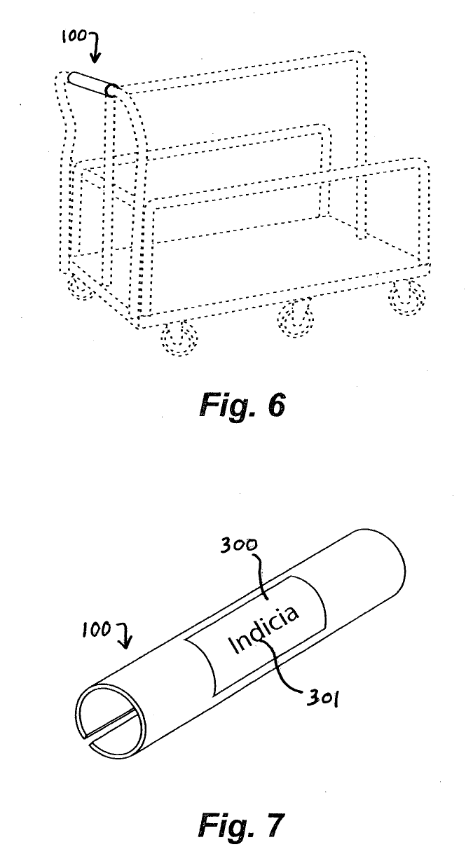

FIGS. 4, 5, and 6 are perspective views of different carts and other push-apparatuses for which a cart handle 100 may be used. Cart handle 100 may be used for a garden variety shopping cart as illustrated in FIG. 4. Cart handle 100 may be used for a heavy cart for use in transporting bulky objects as illustrated in FIGS. 5 and 6. Cart handle 100 may be equally expedient for use with airport luggage carts. In addition, cart handle 100 may be used for handicap railings in restrooms as well. In short, the uses for cart handle 100 are endless. The only difference between the cart handles 100 would lie in the diameter and length in order to be sized correctly to fit on the handle of the various carts illustrated.

In some preferred embodiments, cart handle 100 may be sprayed with a disinfectant for use in killing germs on said cart handle 100. Cart handle 100 in some preferred embodiments may also be treated with other disinfecting protocols such as UV radiation, autoclaving, heat, steam, etc. The specific disinfecting protocol is of no consequence insofar as it actually kill the harmful pathogens.

In some preferred embodiments, cart handle 100 is wrapped with wrapping material 105 as illustrated in FIG. 7. Wrapping material 105 may be either plastic, paper, or any other material expedient for handling cart handle 100. In addition, wrapping material 105 may be treated with sanitation means on both the inside and outside of wrapping material. Since there abound a panoply of expedient materials which may be used for the sanitation of the wrapping material 105, it is not specifically required herein which sanitation means is used. Moreover, since it is well known to one skilled in the art which sanitation means should be used no further detail shall be included herein.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A sanitation handle for carts and railings comprising:
an open tubular flexible sleeve member which is expandable for receiving at least a portion of the main handle member of a cart, said flexible sleeve member having a first open end and a second open end and a slit formed longitudinally along length of flexible sleeve member.

2. The sanitation handle for carts and railings of claim 1 further comprising an adhesive label for printing indicia, said adhesive label having an adhesive surface for affixing to said sanitation handle and a printing surface for said indicia.

3. The sanitation handle of claim 1 wherein said flexible sleeve member is made of recycled paper.

4. The sanitation handle of claim 1 wherein said flexible sleeve member is made of plastic.

5. The sanitation handle of claim 1 wherein said flexible sleeve member is made of vinyl.

6. The sanitation handle of claim 1 further comprising wrapping material, said wrapping material housing and sealing said sanitation handle.

7. The sanitation handle of claim 1 further comprising a disinfectant covering an outer surface of said flexible sleeve member.

8. The sanitation handle of claim 7 wherein disinfectant is a disinfectant spray.

9. A sanitation handle for carts and railings comprising:
an open tubular flexible sleeve member which is expandable for receiving at least a portion of the main handle member of a cart, said flexible sleeve member having a first open end and a second open end and a slit formed longitudinally along length of said flexible sleeve member, an adhesive label for printing indicia, said adhesive label having an adhesive surface for affixing to said sanitation handle and a printing surface for said indicia, wrapping means for use in housing said flexible sleeve member, a disinfectant means for covering outer surface of said flexible sleeve member.

10. The sanitation handle of claim 1 further comprising indicia printed on outer surface of said flexible sleeve member.

11. The sanitation handle of claim 2 wherein said flexible sleeve member is made of recycled paper.

12. The sanitation handle of claim 2 wherein said flexible sleeve member is made of plastic.

13. The sanitation handle of claim 2 wherein said flexible sleeve member is made of vinyl.

14. The sanitation handle of claim 3 further comprising a wrapping means, said wrapping material housing and sealing said sanitation handle.

15. The sanitation handle of claim 3 further comprising a disinfectant covering an outer surface of said flexible sleeve member.

16. The sanitation handle of claim 9 wherein said flexible sleeve member is made of recycled paper.

17. The sanitation handle of claim 9 wherein said flexible sleeve member is made of vinyl.

18. The sanitation handle of claim further comprising a wrapping means, said wrapping material housing and sealing said sanitation handle.

19. The sanitation handle of claim 9 further comprising a disinfectant covering an outer surface of said flexible sleeve member.

20. The sanitation handle of claim 9 further comprising an adhesive label for printing indicia, said adhesive label having an adhesive surface for affixing to said sanitation handle and a printing surface for said indicia.
